(19) United States
(12) Patent Application Publication
(10) Pub. No.: US 2015/0251749 A1
(43) Pub. Date: Sep. 10, 2015

(54) Thrust Plane Orientation Device

(71) Applicant: Paul Edward Sherman, Wrightwood, CA (US)

(72) Inventor: Paul Edward Sherman, Wrightwood, CA (US)

(21) Appl. No.: 14/641,294

(22) Filed: Mar. 6, 2015

Related U.S. Application Data
(60) Provisional application No. 61/949,954, filed on Mar. 7, 2014.

(51) Int. Cl. B64C 15/02; B64C 13/00; B64C 1/00

(52) U.S. Cl. CPC B64C 15/02; B64C 1/00; B64C 13/00

(57) ABSTRACT

The Primary Plane Orientation Device may be orientated such that the lifting surface, and or propulsion group of the aerial vehicle rotates about an axis through the Primary Plane. The Primary Plane, then, may be orientated at any chosen angular offset from the vehicle axis such that the lifting surfaces can produce thrust at said angle to the vehicle axis. The orientation of the Primary plane may then smoothly transform to other desired angles such that the aerial vehicle remains unstalled during conversion between VTOL-rotary and fixed wing flight. The lifting surface, and/or propulsion groups may then be fixed in any orientation to the axis of the vehicle to produce fixed wing lift, or propulsion in line with the fuselage or at various offsets from the fuselage.

### CROSS-REFERENCE TO RELATED APPLICATIONS

This application claims the benefit of U.S. Provisional Application No. 61/949,954, filed Mar. 7, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF INVENTION

The field of the invention is aeronautics, and, more particularly, to aircraft design that combine the features of vertical takeoff and landing (VTOL) modes, and, fixed wing modes of flight.

### BACKGROUND OF THE INVENTION

The following description includes information that can be useful in understanding the present invention. It is not an admission that any of the information provided herein is prior art or relevant to the presently claimed invention, or that any publication specifically or implicitly referenced is prior art.

What is lacking in attempted solutions that allow transformations between (VTOL) and fixed wing flight, within this field, is the ability for an aerial vehicle with lifting surfaces, and/or propulsion groups, to transform between (VTOL) and fixed wing flight modes, while facilitating a fuselage which remains rotationally stable without compromising the speed and range capabilities of fixed wing airplanes. Furthermore, the industry requires a solution which facilitates an unstalled lifting surface that maintains relatively low angles of attack with regard to the air flow direction during transformations between rotor wing mode to fixed wing configuration.

Methods exist that provide transformation between (a) rotating propulsion and/or (b) lifting elements that return to fixed wing aircraft configuration (U.S. Pat. No. 8,157,203 to Kinsey titled “Methods and Apparatus for Transforming Unmanned Aerial Vehicle”). However, this transformation provides rotational instability that can be harmful to sensitive payloads within the fuselage. Thus, there is still a need for an apparatus and methods that can stabilize the fuselage in the transition from vertical takeoff and landings (“VTOL”) to cruise flight modes. Furthermore, methods that require the fuselage to start upright, like a rocket, and/or which require the rotation of the rotor to act about a fixed axis, suffer from poor transformation capability between hovering and cruise flight configurations.

Designs such as the canard rotor wing configuration suffer drawbacks because they are not able to use the rotor for stability during the transition between rotor and stop rotor flight modes, and therefore suffer drag penalties due to added fixes such as additional wings and/or modifications to the fuselage that are required in order to provide transformation stability. Similarly, compound helicopter designs have complex rotor systems, in addition to wings, that suffer from added weight and drag. “Tilt rotor” configurations seek the elimination of a rotor wing configuration by utilizing rotating propellers, and are associated with poor hover efficiency. Additionally, tilt rotor designs suffer in cruise due to the complexity of the propeller systems, and therefore are not optimized for cruise flight efficiency. Tilt duct designs that use propellers in shrouded ducts, suffer from poor hover efficiency in hover mode and high drag in fixed wing flight. Thus, combining an airplane's high speed, and long range capability, within an aircraft design that achieves stability without efficiency tradeoffs throughout the transformation between (VTOL) and fixed wing flight, remains a significant aspect in aeronautical engineering.

Kinsey and all other publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Throughout the claims that follow, the meaning of “Smeared State Flight Mode” is defined as a flight mode that combines attributes of an “aileron roll” flight mode with attributes of a “rotor” flight mode into a hybrid flight mode that can perform “Cyclic” and “Collective” controls as well as “Roll,” “Pitch,” and “Yaw” maneuvers simultaneously about an axis that is independent from the centerline axis of the fuselage, and is capable of maintaining steady state unstalled flight during the maneuver, and additionally allows a fuselage to remain rotationally stable throughout the maneuver.

Throughout the claims that follow, the meaning of “Primary Plane” is defined as a geometric reference plane that can be oriented in positions not necessarily parallel with the pitch, yaw, and roll planes of the fuselage described on the aerial vehicle. Additionally, the “Primary Plane” contains and axis of rotation normal to its geometric plane, about which rotations may be described, and additionally through which thrust may be understood to act upon the “Primary Plane” normal direction. For clarity, the use of the term “Normal” is defined as the direction perpendicular to a geometric plane.

The inventive subject matter provides apparatus, systems and methods in which a Primary Plane Orientation Device, which facilitates the repositioning of a vehicle's Primary Plane with respect to the fuselage centerline axis, and additionally positions the aircraft control system (lifting surfaces and/or propulsion groups) relative to the Primary Plane's orientation, facilitates a rotationally stabile fuselage within an aircraft that is efficient in all modes of flight including vertical takeoff and landing (VTOL), and cruise flight modes, and Smeared State flight modes.

### BRIEF DESCRIPTION OF THE SEVERAL VIEWS OF THE DRAWING

FIG. 1 representatively illustrates a perspective view of the primary plane orientation device, in accordance with an exemplary embodiment of the present invention in a (VTOL) configuration suitable for vertical takeoff and landing in rotor wing flight mode;

FIG. 2 representatively illustrates a side view of the primary plane orientation device in an (VTOL) configuration suitable for vertical takeoff and landing in rotor wing flight mode;

FIG. 3 representatively illustrates the side view of the primary plane orientation device in a configuration suitable for Smeared State flight mode;

FIG. 4 representatively illustrates a side view of the Primary Plane Orientation Device in a configuration suitable for fixed wing flight mode.

### DETAILED DESCRIPTION OF THE PREFERRED EMBODIMENT

It should be apparent to those skilled in the art that many more modifications besides those already described in this present invention are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

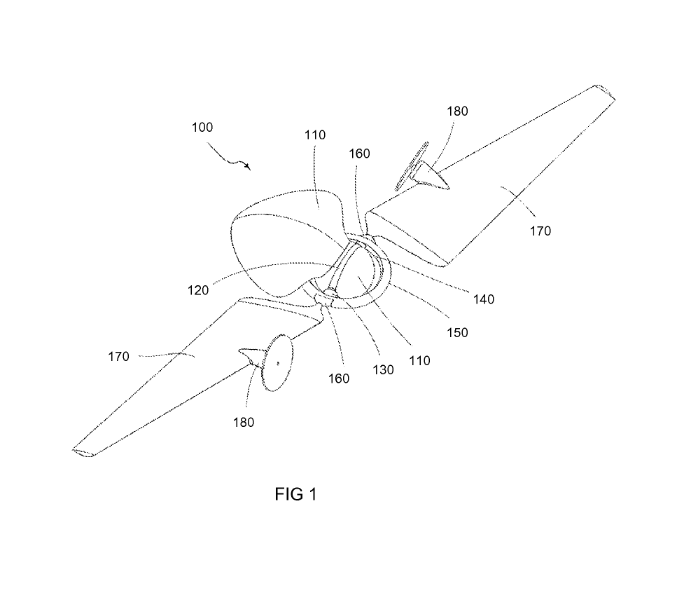

FIG. 1 is a perspective view of an aircraft 100 according to a preferred embodiment of the present invention that may be configured for multiple flight modes, such as vertical takeoff and landing (VTOL) mode, and fixed wing flight mode, and smeared state flight mode. Thus the primary plane orientation device may fly as a more traditional fixed wing aircraft, and can take off and land as a (VTOL) aircraft with a wing used as a rotor, and can fly in the smeared state flight mode in between fixed wing and rotor flight modes such that the efficient use of the lifting surfaces provide continuous stable unstalled flight with a fuselage that remains rotationally stable during transformations.

The aircraft 100 may comprise of fuselage 110, a fuselage-race 120 that is connected to inner-race 140 by means of pivot 130. Furthermore, inner-race 140 may connect rotationally to outer race 150 such that outer race 150 may rotate about inner-race 140, or may lock to inner race 140 as required. Additionally, outer-race 150 may attach to pivot-slider system 160. The pivot-slider system 160 represents one of any number of such attachments as required to facilitate any number of lifting surfaces 170 and/or propulsion systems 180. It should be apparent to those skilled in the art that suitable electro mechanical servos and/or piezo systems are capable of actuating the various connections between pivots and rotary connections. For example, in one embodiment, the interface between inner-race 140 and outer-race 150 may include, but is not limited to the use of a drive servo-motor capable of rotating inner-race 140 at a given rpm equal and opposite to the outer-race 150 rpm, and therefore hold the fuselage 110 substantially stationary while the outer-race 150 spins. In another embodiment, inner-race 140 may lock to outer race 150 by use of a firing pin or other suitable attachment scheme. Furthermore, and embodiment may use roller bearings between inner-race 140 and outer-race 150. Fuselage 110 may be configured in various ways not depicted, such as a tube, or a pod and boom, or any other such configurations as necessary for various missions.

Aircraft 100 may comprise of one or more conventional horizontal and/or vertical stabilizers as part of the fuselage 110 that may be configured to mount directly to outer-race 150 or to fuselage 110 in order to provide stability at as needed throughout all flight modes. Additionally, the fuselage 110 may be configured to be manned or un-manned and may accommodate cargo with sensitive payloads. Furthermore, fuselage 110 may be a lifting body that is detachable from the other components, and fuselage 110 may be comprised of a larger lifting body configuration, such as a flying wing. Additionally, fuselage 110 may have landing gear and/or a propulsion systems in push or pull configurations.

In one embodiment, fuselage 110 may be connected directly to fuselage-race 120 by a servo controlled interface that actuates the fuselage-race 120 to rotate about the fuselage 110 centerline axis in order that the orientation of pivot 130 may be repositioned at angles that produce a lateral orientations of inner-race 140 and outer-race 150. In another embodiment, fuselage 110 may omit fuselage-race 120, and therefore connect directly to inner-race 130, wherein the axis about which outer-race 150 may spin would always lie substantially inside the pitch plane of the fuselage 110.

The “Primary Plane” in aircraft 100 can be understood specifically as the plane normal to the axis about which outer race 150 may rotate. Furthermore, it should be apparent that inner-race 140 may pivot about pivot 130 in order to reorient the primary plane to be at any angle more or less between the thrust direction of fixed wing flight, and the thrust direction of (VTOL) rotor wing flight modes and anywhere in between as necessary for smeared state flight modes.

Pivot 130 may rotate substantially in order to reposition inner-race 140 from a first position, more or less in line with the fuselage 110 centerline axis, to a second position more or less substantially perpendicular to the fuselage 100 centerline axis. For example, pivot 130 may rotate the inner-race 140 such that outer-race 150 moves to a start position substantially 45 degrees from a parallel with the ground in order to provide a smeared state flight mode that allows a slow forward hover condition that may be required to enter a small landing field. In another example, pivot 130 may hold the fuselage 110 stationary in a horizontal heading during (VTOL) rotary-wing modes, as outer-race 150 spins under the thrust of propulsion group 180, and while inner-race 140 is counter rotated by a servo motor that allows lifting surfaces 160 to spin without causing a rotational moment to result on the fuselage 110. Similarly, an embodiment with fuselage-race 120 may become actuated in order to roll the fuselage about its centerline axis, in order to accommodate a stable horizontal fuselage while the Primary Plane rolls left or right during rotary wing flight maneuvers.

Outer-race 150 may accommodate attachment to pivot-slider system 160 by means of a slide mechanism that allows pivot-slider system 160 to index circumferentially about the outer circumference of outer-race 150. For example, in one embodiment, there may be two instances of pivot-slider systems 160 that are initially positioned 180 degrees opposed to one another as depicted in FIG. 1, and it may be of interest to move them into a second arrangement wherein they are positioned 120 degrees apart, such that a delta wing configuration is achieved in fixed-wing flight mode.

The pivot-slider system 160 may attach to outer lifting surface 170 and/or may attach directly to propulsion group 180 in configurations that do not utilize outer lifting surface 170. In one embodiment, lifting surface 170 is outfitted with propulsion group 180 such that the attachment of the lifting surface 170 is onto a round spar extending out of pivot slider system 160, and therefore allows the lifting surface 170 to be rotated and/or oscillated, as necessary, about the round spar in order to accommodate transient and/or steady state flight authority throughout the various flight modes such as cyclic, collective, and roll. In another embodiment, a round spar extending out from pivot slider system 160, may angle up or down in the direction of dihedral with respect to outer-race 150, and/or may angle fore or aft in the direction of swing-wing with respect to outer race 150 in order to produce trim offsets between outer-race 150, and lifting surface 170. Therefore, lifting surface 170 and/or propulsion system 180, may move in vectors independent of outer-race 150 in order to position lifting surface 170 and/or propulsion groups 180 into positions that are not parallel with the primary plane orientation as required for control inputs and/or trim offsets. Additionally, pivot-slider system 160 may attach directly to propulsion group 180 in a configuration that allows aircraft 100 to fly without lifting surfaces and therefore allow for multiples of propulsion system 180 to spin about the primary plane axis, thereby producing a gyroscopically stable aircraft under pure thrust configurations.

The lifting surface 170 provides a lifting force on the aerial vehicle. The lifting surface 170 may be a cambered airfoil, or a morphing structure, or any suitable lifting surface capable of generating lift in the air flow direction and/or in the reverse air flow direction. Furthermore, lifting surface 170 may include various ailerons and/or flaps for control inputs that include but are not limited to aileron, flap, ailervator, flaperon, elevons, spoileron, and others as necessary to produce control inputs during all flight modes. It should be apparent to those skilled in the art, that the ailerons and flaps may be used to perform collective and cyclic authority on the aerial vehicle by oscillating about various offset positions.

The propulsion system 180 may be comprised of any suitable system for providing thrust such as but not limited to rockets, motor-driven propeller, a turbofan, a jet, or electric motors. The propulsion system may consist of hybrid-electric power sources or be adapted to operate off of solar, or batteries, or any other suitable power source including ones not mentioned here. Power for all systems may originate from within the fuselage 110 and/or may be stored in the lifting surfaces 170 and may be shared between the fuselage 110 and lifting surfaces 170 and/or propulsion system 180. Furthermore, propulsion systems may be configured as push or pull systems, and can be mounted on the lifting surface 170 and/or, as needed, on other locations upon the aircraft 100, such as the fuselage 110 and the pivot slider system 160. In an embodiment, the propulsion groups 180 may be situated inside the fuselage in a configuration that directs thrust out of the fuselage and along a manifold path configured to provide thrust vectoring between the fuselage and the Primary Plane Orientation Device, such that lifting surfaces 170 may spin without needing propulsion groups 180 mounted outside the fuselage.

In various embodiments, cyclic output between inner-race 140 and outer-race 150 may be required which may be communicated by means of signals electronically sent to control servos, or may be communicated through cam-follower systems or swash plates as required, but are not limited to those options mentioned. In one embodiment, a cam-follower system accommodates cable systems to control all flight systems without the need for servo attachments, and therefore, the aircraft can directly be controlled by a manned mission without any electronic actuation required. In another embodiment, a mixture of hand operated controls and redundant servo actuation systems act in conjunction in order to operate all flight control systems.

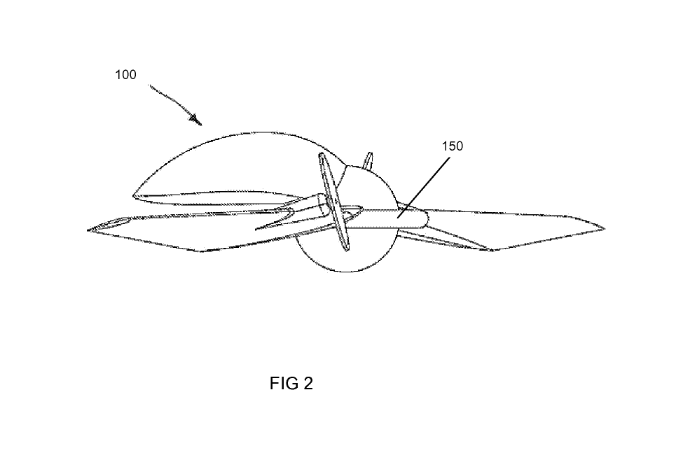

Referring to FIG. 2, during launch and/or landing of the aerial vehicle, the Primary Plane Orientation Device orients the Primary Plane more or less in line with (VTOL) lift direction with the lifting surfaces 170 and/or propulsion systems 180 in a rotary mode configuration. Additionally, in FIG. 2, the leading edges of the lifting surfaces 170 and/or propulsion groups 180 are orientated in substantially opposed directions from one another. An alternative embodiment of FIG. 2 could allow the leading edges to face substantially in the same direction thereby running one leading edge forward and one leading edge backward in the reverse air flow direction with regard to the flow direction during (VTOL) operations, although this is less preferred.

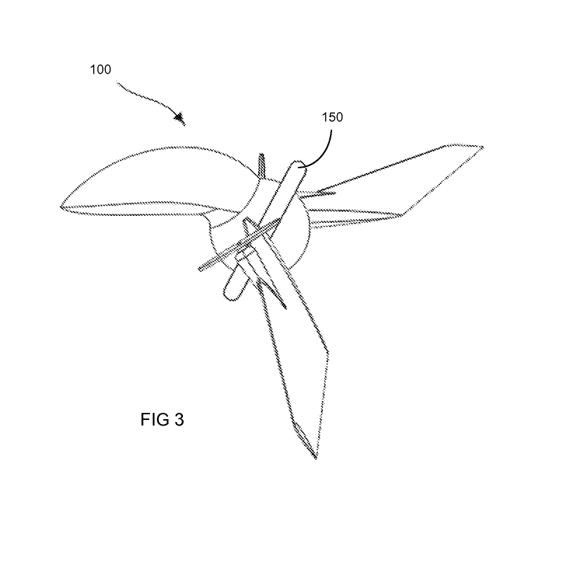

Referring to FIG. 3, aircraft 100 is in representational depicted in the smeared state flight mode wherein the thrust direction is vectored partly in the direction of lift and partly in the direction of thrust. Also in FIG. 3, outer-race 150 is depicted more or less with the Primary Plane positioned at a 45 degree orientation with respect to the fuselage 110 lift direction, and therefore would allow steady slow forward flight in the smeared state flight mode, and therefore allow approach and departure maneuvers within short field and restricted sites.

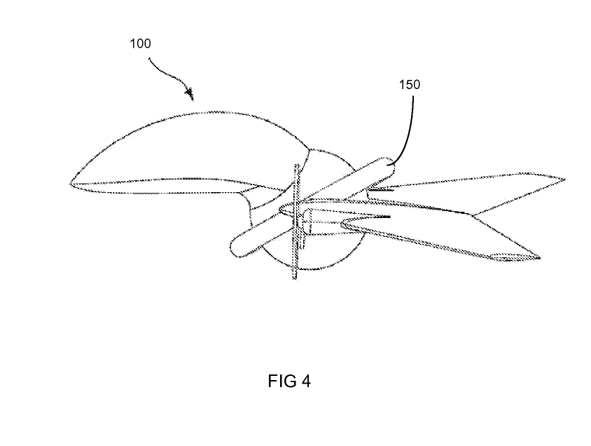

Referring to FIG. 4, during transformation between the smeared state, and fixed wing flight, the Primary Plane Orientation Device orients the Primary Plane axis substantially in the line with the fuselage 110 centerline axis, and further allows the aircraft 100 to exit the smeared state and enter a pure aileron roll, and then stop the aileron roll in order to resume fixed wing flight. Additionally, It should be apparent to those skilled in the art, that aircraft 100, may in fixed wing flight mode, perform conventional take off and landings.

The Primary Plane Orientation Device is more accommodating to manned aircraft or unmanned aircraft with sensitive payloads which benefit from a fuselage that substantially does not rotate on any axis during the transformation between VTOL and cruise modes.

A further benefit is the ability of the Primary Plane Orientation Device to smoothly reorient the Primary Plane vector as the aircraft transitions between VTOL and cruise while allowing an independent propulsion group to vary its RPM within the primary plane such that all phases of flight remain smooth, and mitigate the need for flight surfaces which stall and recover at any phase of the flight envelope.

What is claimed is:

1. An aircraft comprising:
a fuselage;
a Primary Plane Orientation Device having at least one of a propulsion group and/or a lifting surface; and
a coupling that allows rotation between a plane of the fuselage and a plane of the Primary Plane Orientation Device.

2. The aircraft according to claim 1, wherein the lifting surface is configured to rotate about the fuselage in a manner that provides gyroscopic as well as cyclic control stability to the aircraft.

3. The aircraft according to claim 1, wherein the coupling is configured to provide rotational stability to the fuselage during takeoff cruise and landing configurations, independent of orientation of the Primary Plane of the Primary Plane Orientation Device.

4. The aircraft according to claim 1, wherein the propulsion system is configured to provide gyroscopic stability, while achieving secondary angular vectoring outside of the Primary Plane of the Primary Plane Orientation Device.

5. The aircraft according to claim 1, further comprising first and second wings having first and second leading edges, respectively, wherein the first leading edge and the second leading edge face in substantially opposite directions during takeoff and landing modes.

6. A method of transforming between VTOL and fixed wing flight in an aircraft, wherein the aircraft does not require a stall or disruption in lift, the method comprising:
providing the aircraft with wings positioned on a race that is rotatably disposed about a fuselage;
rotating the race in a Primary Plane at a speed sufficient to lift the aircraft;
rotating the Primary Plane approximately 45 degrees to a “Smeared State” in which both aileron roll and rotary mode both exist; and
rotating the Primary Plane approximately 90 degrees to a “Thrust” position and maneuver the wings to a delta wing configuration.

7. A method of transforming between VTOL and forward flight in an aircraft having a fuselage and wings and a propulsion group, the method comprising:
steadying an orientation of the fuselage while at least one of the wings and the propulsion group rotate in a Primary Plane about the fuselage;
rotating the Primary Plane from a substantially horizontal VTOL configuration to a forward flight configuration.

8. A method of rotating a Primary Plane in an aircraft from a propulsion group situated on the outside of a fuselage, the method comprising:
where wings are present on the Primary Plane, and wherein the propulsion group provides thrust necessary to generate a rotary driven lift when operated in a “Smeared State Lift” where both rotary thrust and aileron roll lift are produced, orienting the wings into a delta wing configuration such that the aileron roll lift diminishes to zero RPM; and
where wings are present on the Primary Plane, operating the propulsion group to provide gyroscopic and cyclic stability within an ascent of the fuselage through to horizontal flight.

9. A method of rotating a Primary Plane Orientation Device about a fuselage of an aircraft, the method comprising:
utilizing an inner bearing and an outer race as a manifold path configured to provide thrust vectoring between the fuselage and the Primary Plane Orientation Device.

11. A method of effecting vertical takeoff and landing of an aircraft having a fuselage, a wing and a propulsion group, the method comprising rotating the propulsion group and the wing about the fuselage in a manner that provides gyroscopic stability to the fuselage and lift to the aircraft.

12. An aircraft, comprising:
a fuselage comprising a forward end and an aft end; and
an aircraft flight control system configured to carry out translational or rotational assignments independent of the fuselage centerline position.

13. The aircraft of claim 12, wherein the aircraft is manned.

14. The aircraft of claim 12, wherein the aircraft is unmanned.

15. The aircraft of claim 12, further comprising at least first and second main wings that are rotatably coupled to the fuselage.

16. The aircraft of claim 15, wherein the first and second wings rotate about the fuselage in a rimary Plane, and further comprising a propulsion group configured to rotate about the fuselage at a speed that is independent of rotation of the wings about the fuselage.

17. The aircraft of claim 12, wherein the first and second wings rotate about the fuselage in a Primary Plane, and wherein the aircraft flight control system is configured to perform assignments axially, rotationally, and translationally offset from the Primary Plane.

18. An aircraft, comprising:
a fuselage comprising a forward end and an aft end, and having a centerline position; and an aircraft flight control system configured to perform at least one of a translational assignment and a rotational assignment independent of the fuselage centerline position.

19. An aircraft, comprising:
a fuselage comprising a forward end and an aft end; an aircraft flight control system; a Primary Plane Orientation Device; and
wherein the aircraft control system is configured to operate the Primary Plane orientation device to carry out assignments at least one of axially, rotationally, and translationally offset from a Primary Plane axis and a datum point.
